(19) United States
(12) Patent Application Publication
(10) Pub. No.: US 2024/0039097 A1
(43) Pub. Date: Feb. 1, 2024

(54) BATTERY PACK

(71) Applicant: TOYOTA JIDOSHA KABUSHIKI KAISHA, Toyota-shi Aichi-ken (JP)

(72) Inventors: Yugo MOCHIZUKI, Nisshin-shi Aichi-ken (JP); Yutaroh Gotoh, Toyota-shi Aichi-ken (JP); Masataka Ogushi, Toyota-shi Aichi-ken (JP); Junki Sugimoto, Toyota-shi Aichi-ken (JP); Mitsuharu Goto, Toyota-shi Aichi-ken (JP)

(73) Assignee: TOYOTA JIDOSHA KABUSHIKI KAISHA, Toyota-shi Aichi-ken (JP)

(21) Appl. No.: 18/199,086

(22) Filed: May 18, 2023

(30) Foreign Application Priority Data
Aug. 1, 2022 (JP) 2022-122828

(51) Int. Cl. H01M 50/209; B60L 50/64; H01M 50/289

(52) U.S. Cl. CPC H01M 50/209; B60L 50/64; H01M 50/289; H01M 2220/20

(57) ABSTRACT

The battery pack includes a cell stack and a battery case. The cell stack is formed by stacking a plurality of battery cells having a substantially rectangular parallelepiped shape. The battery case is formed in a substantially rectangular parallelepiped shape and accommodates the cell stack. The battery case includes a first protrusion protruding from an outer surface of the battery case to an outside of the battery case at a position of a gap between adjacent battery cells in a stacking direction of the cell stack.

### CROSS-REFERENCE TO RELATED APPLICATION

This application claims priority to Japanese Patent Application No. 2022-122828 filed on Aug. 1, 2022, incorporated herein by reference in its entirety.

### BACKGROUND

### 1. Technical Field

The present disclosure relates to a battery pack.

### 2. Description of Related Art

Japanese Unexamined Patent Application Publication No. 09-086188 (JP 09-086188 A) discloses a battery case. A plurality of cylindrical battery cells is accommodated in the battery case. Reinforcing ribs are provided on the inner surface of the battery case so as to protrude between adjacent battery cells.

### SUMMARY

In a battery pack including a cell stack formed by stacking a plurality of battery cells having a substantially rectangular parallelepiped shape and a battery case accommodating the cell stack, there is a possibility that an impact is applied to the battery cells from a member around a wall portion of the battery case covering the cell stack via the wall portion. The battery pack is required to have a structure capable of reducing an impact applied to the battery cells in this manner.

The present disclosure has been made in view of the above-described problem, and an object of the present disclosure is to provide a battery pack capable of reducing an impact applied to a battery cell from a member around a battery case through a wall portion of the battery case.

A battery pack according to the present disclosure includes a cell stack and a battery case. The cell stack is configured by stacking a plurality of battery cells with a substantially rectangular parallelepiped shape. The battery case is provided in a substantially rectangular parallelepiped shape and accommodates the cell stack. The battery case includes a first protrusion protruding from an outer surface of the battery case to an outside of the battery case at a position of a gap between adjacent battery cells in a stacking direction of the cell stack.

The battery case may include a pair of side walls. The pair of side walls may extend along the stacking direction and face a side surface of the cell stack. The first protrusion may be provided on at least one of the pair of side walls.

The battery case may include a second protrusion that protrudes from an inner surface of the battery case to be interposed between the adjacent battery cells on an inner side of the first protrusion.

The battery case may include a pair of side walls. The pair of side walls may extend along the stacking direction and face the side surfaces of the cell stack. The first protrusion and the second protrusion may be provided on at least one of the pair of side walls. The battery case may include a first rib provided on an outer surface of at least one of the pair of side walls on which the first protrusion and the second protrusion are provided. The first rib may be provided to extend parallel or obliquely to the stacking direction.

The first protrusion provided on at least one of the pair of side walls may be provided for each gap of the adjacent battery cells in the cell stack, and may be provided so as to extend along a gap of the adjacent battery cells. The first rib may be provided so as to bridge between the first protrusions adjacent to each other.

The battery case may include: an upper wall extending along the stacking direction and facing an upper surface of the cell stack; a third protrusion protruding from an inner surface of the upper wall so as to be interposed between the adjacent battery cells; and a second rib provided on an outer surface of the upper wall. The second rib may be provided to extend parallel or obliquely to the stacking direction.

The battery case may include: a bottom wall extending along the stacking direction and facing a bottom surface of the cell stack; a third protrusion protruding from an inner surface of the bottom wall so as to be interposed between the adjacent battery cells; and a second rib provided on an outer surface of the bottom wall. The second rib may be provided to extend parallel or obliquely to the stacking direction.

According to the battery pack of the present disclosure, it is possible to reduce an impact applied to a battery cell from a member around the battery case via a wall portion of the battery case, by utilizing a simple configuration of a first protrusion provided on an outer surface of the battery case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view for explaining an example of a configuration of a battery pack according to an embodiment;

FIG. 2 is a perspective view showing the entire configuration of the upper case shown in FIG. 1;

FIG. 3 is a view of the upper case from the direction of arrow A in FIG. 2;

FIG. 4 is a cross-sectional view of C-C line in FIG. 3;

FIG. 5 is a perspective view showing an internal structure of the upper case shown in FIG. 1;

FIG. 6 is a side view of the upper case shown in FIG. 1 as viewed from the side of the side wall;

FIG. 7A is an enlarged view of a portion D of FIG. 4;

FIG. 7B is an enlarged view of a portion D of FIG. 4;

FIG. 8 is a diagram for explaining an additional problem I1 according to the embodiment;

FIG. 9 is a diagram for explaining an additional problem I2 according to the embodiment;

FIG. 10 is a top view of the upper case shown in FIG. 1 as viewed from the side of the upper wall;

FIG. 11 is a bottom view of a lower case according to a modification of the embodiment as viewed from a side of a bottom wall;

FIG. 12 is a view for explaining the structure of the restraining member shown in FIG. 1; and

FIG. 13 is a diagram for explaining an additional problem I3 according to the embodiment.

### DETAILED DESCRIPTION OF EMBODIMENTS

Embodiments of the present disclosure will be described below with reference to the accompanying drawings. Elements common to each figure are given the same reference signs, and overlapping descriptions are omitted or simplified.

### Overall Configuration of the Battery Pack

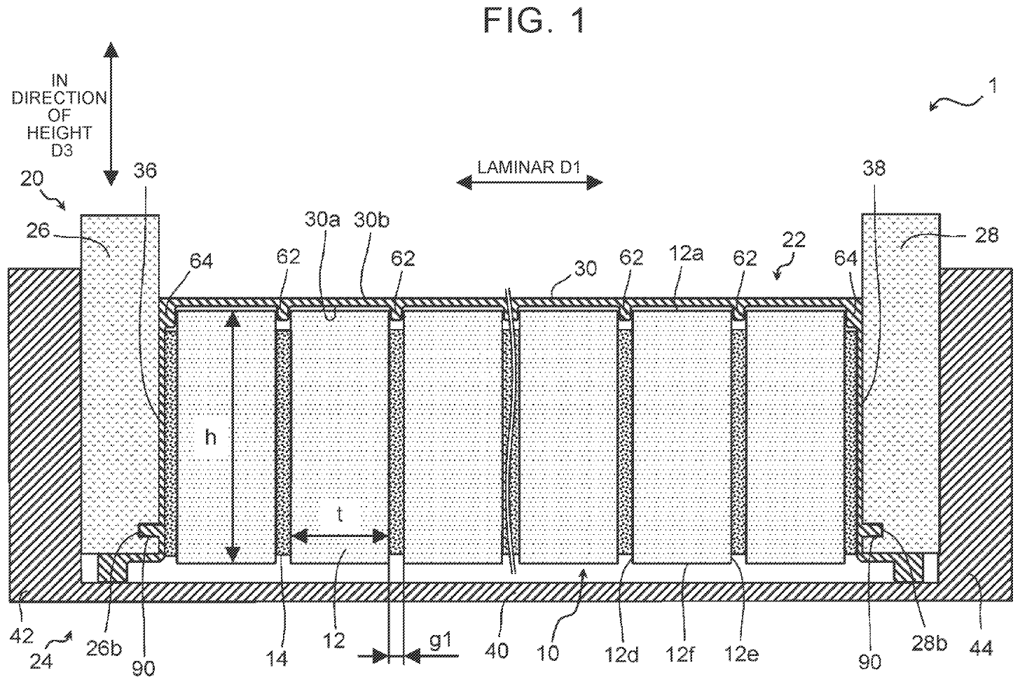

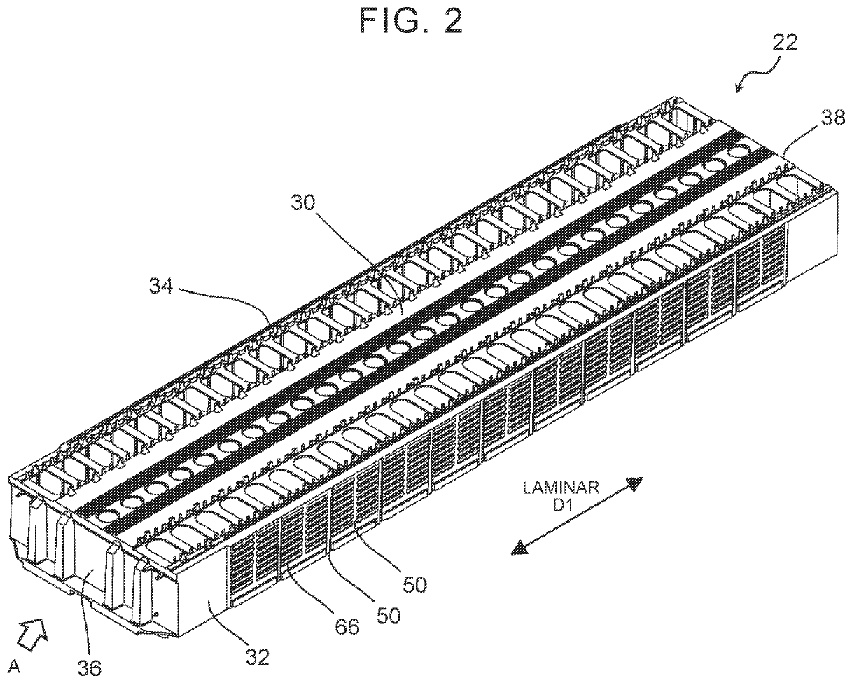

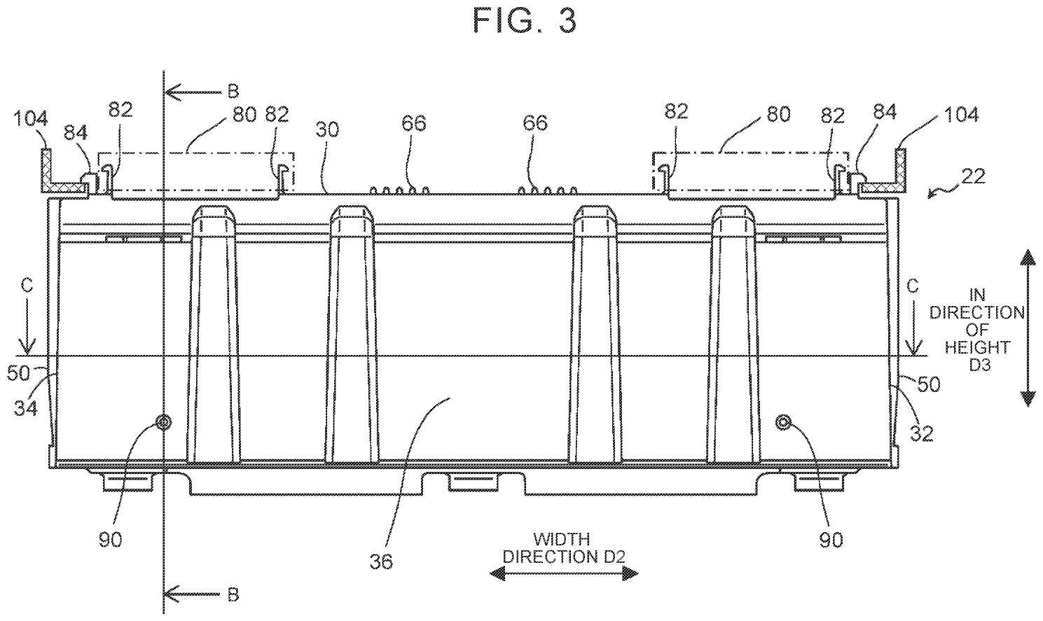

FIG. 1 is a cross-sectional view for explaining an example of a configuration of a battery pack 1 according to an embodiment. FIG. 2 is a perspective view showing the entire configuration of the upper case 22 shown in FIG. 1. FIG. 3 is a view of the upper case 22 from the direction of the arrow A in FIG. 2. More specifically, FIG. 1 is a cross-sectional view taken along B-B line of FIG. 3.

The battery pack 1 includes a cell stack 10 and a battery case 20. The battery pack 1 is mounted on an electrified vehicle such as a battery electric vehicle (BEV) and supplies electric power to electrified vehicle.

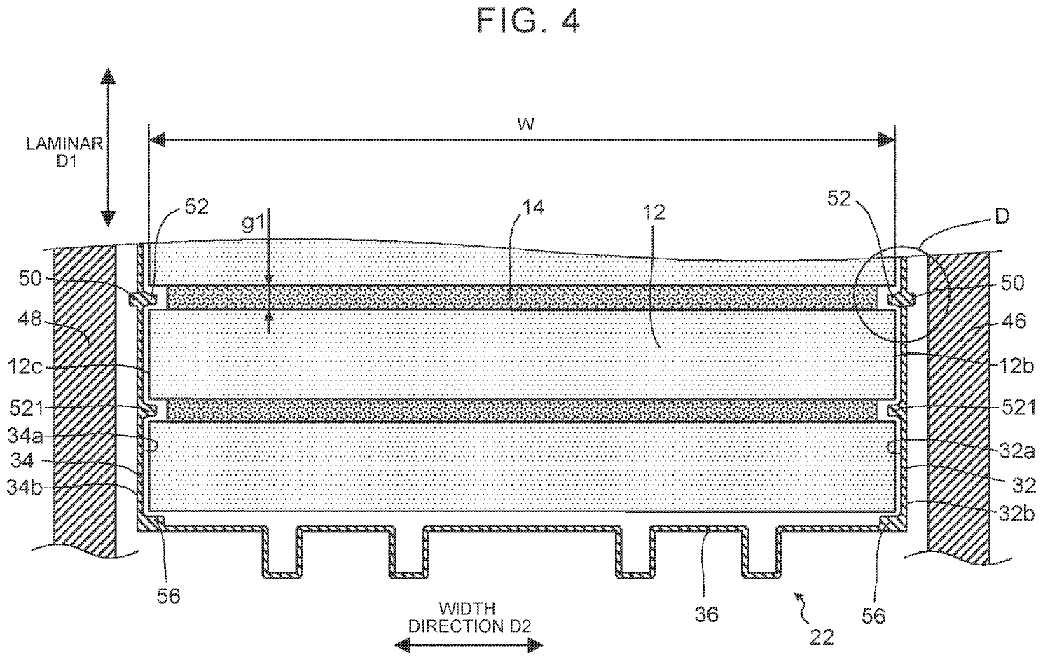

The cell stack 10 is formed by stacking a plurality of battery cells 12. Each battery cell 12 has a substantially rectangular parallelepiped shape (more specifically, for example, a substantially flat rectangular parallelepiped shape). That is, the respective battery cells 12 have an outer shape in which the thickness t (the length in the stacking direction D1) is smaller than the height h and the width w (see FIG. 4 to be described later). The stacking direction D1 is a direction in which the cells 12 are stacked in the cell stack 10. Each battery cell 12 is, for example, a square cell, but may be, for example, a laminate type (pouch type).

More specifically, the cell stack 10 is configured by alternately stacking a plurality of battery cells 12 and a thin plate-shaped elastic body 14 one by one in the stacking-direction D1. That is, the adjacent battery cells 12 are arranged at a gap g1 corresponding to the thickness of the elastic body 14. More specifically, the elastic body 14 is, for example, an elastic heat insulating material.

The battery case 20 is formed in a substantially rectangular parallelepiped shape and houses the cell stack 10. The battery case 20 includes an upper case 22 and a lower case 24. The upper case 22 and the lower case 24 are made of resin, for example. Alternatively, the upper case 22 may be made of metal, for example. Similarly, the lower case 24 may be made of, for example, metal. The battery pack 1 includes a pair of restraining members 26 and 28.

The upper case 22 includes an upper wall 30 and four side walls 32-38. The upper wall 30 and the four side walls 32 to 38 are integrally formed. The upper wall 30 faces the upper surface 12a of the cells 12 constituting the cell stack 10. A pair of electrode terminals (a positive electrode terminal and a negative electrode terminal) and a safety valve (not shown) are provided on the upper surface 12a of the respective battery cells 12. The four side walls 32 to 38 are a pair of side walls 32 and 34 and a pair of end walls (side walls) 36 and 38. The pair of side walls 32 and 34 are formed so as to extend along the stacking-direction D1. The pair of side walls 32 and 34 respectively face the side surfaces 12b and 12c (see FIG. 4) of the respective battery cells 12 constituting the cell stack 10. The pair of end walls 36 and 38 are side walls located at the ends of the lamination-direction D1, respectively. The pair of end walls 36 and 38 respectively face the side surfaces 12d and 12e of the battery cells 12 located at the respective ends of the cell stack 10.

The lower case 24 includes a bottom wall 40 facing the bottom surface 12f of the respective battery cells 12 constituting the cell stack 10, and a pair of end walls 42 and 44. The bottom wall 40 and the pair of end walls 42 and 44 are integrally formed. The pair of end walls 42 and 44 of the lower case 24 are located on the outer sides of the pair of end walls 36 and 38 of the upper case 22 in the stacking-direction D1, respectively.

As shown in FIG. 1, a restraining member 26 is press-fitted between the end wall 36 and the end wall 42. Similarly, a restraining member 28 is press-fitted between the end wall 38 and the end wall 44. The restraining members 26 and 28 are, for example, spacers made of resin. According to such a configuration, a load for compressing the cell stack 10 in the stacking-direction D1 (in other words, a load for restraining the plurality of battery cells 12 constituting the cell stack 10) can be generated by using the pair of end walls 42 and 44 of the lower case 24. In addition, according to such a structure, a frictional force based on the restraining load acts between the upper case 22 mounted on the lower case 24 and accommodating the cell stack 10 and the lower case 24 via the restraining members 26 and 28. The upper case 22 can be held with respect to the lower case 24 by using the frictional force.

Further, the lower case 24 includes a pair of cross members 46 and 48 (see FIG. 4) which are reinforcing members. The cross member 46 covers a portion of the side wall 32 of the upper case 22 and is formed to bridge between the end wall 42 and the end wall 44 of the lower case 24. Similarly, the cross member 48 covers a portion of the side wall 34 of the upper case 22 and is formed to bridge between the end wall 42 and the end wall 44 of the lower case 24.

Note that the above-described battery pack 1 includes one upper case 22 that accommodates one cell stack 10. Instead of such an example, the “battery pack” according to the present disclosure may include a plurality of upper cases 22 each accommodating a plurality of cell stacks 10. For example, the plurality of upper cases 22 may be mounted on the same lower case in parallel.

Further, the upper wall 30 of the upper case 22 described above functions as a protective plate on the upper surface 12a of the respective battery cells 12. Specifically, the upper wall 30 can protect the upper surface 12a of the respective battery cells 12 so as not to be directly touched by an operator who manufactures the battery pack 1. In addition, when one battery cell 12 constituting the cell stack 10 generates abnormal heat, high-temperature contents (heat source bodies) ejected from the safety valve of the battery cell 12 can be prevented from adhering to the surrounding battery cell 12 (that is, chain smoke generation can be suppressed).

### First Convex Portion and Second Convex Portion

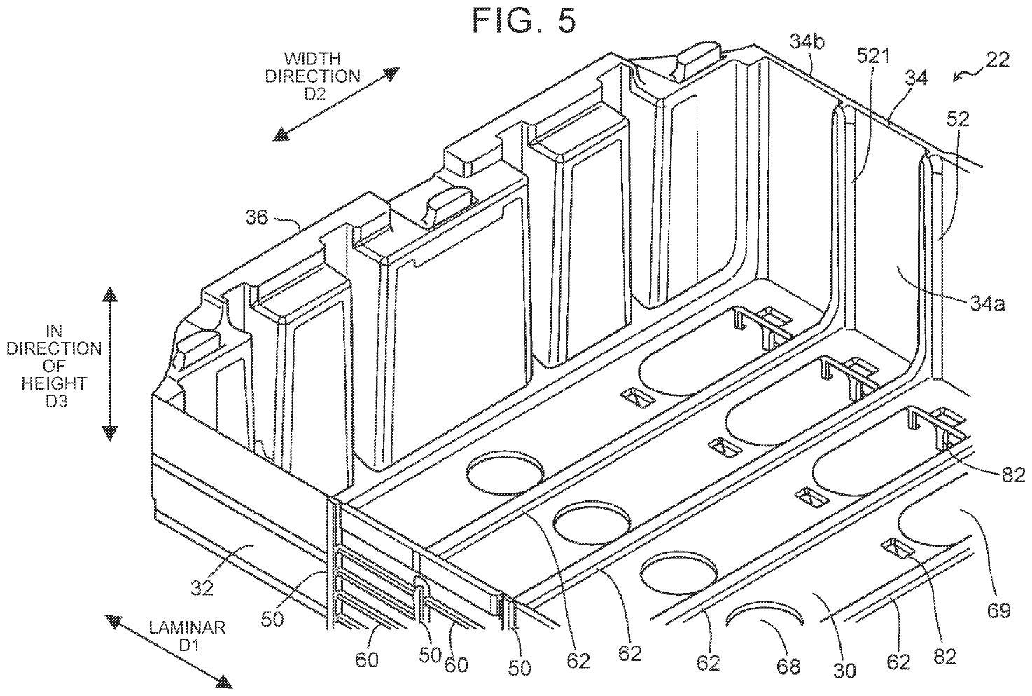

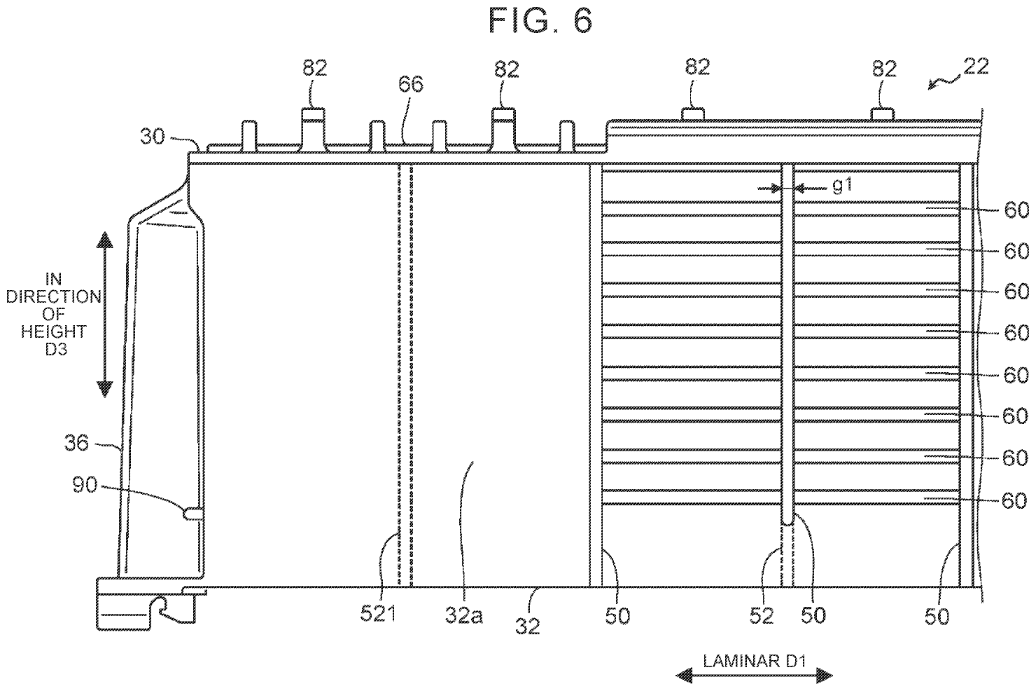

FIG. 4 is a cross-sectional view taken along a C-C line in FIG. 3. FIG. 5 is a perspective view showing an internal structure of the upper case 22 shown in FIG. 1. FIG. 6 is a side view of the upper case 22 shown in FIG. 1 as viewed from the side of the side wall 32.

The upper case 22 includes a first protrusion 50 and a second protrusion 52. The first protrusion 50 and the second protrusion 52 are integrally formed with the upper case 22. The first protrusion 50 and the second protrusion 52 are basically provided between the respective battery cells 12 in the plurality of battery cells 12 constituting the cell stack 10.

The second protrusions 52 are provided for positioning the cells 12 in the stacking-direction D1. Specifically, the second protrusion 52 is formed on the inner surface of the upper case 22. In the upper case 22, the second protrusions 52 are formed on the inner surfaces 32a and 34a of the pair of side walls 32 and 34, respectively. As shown in FIG. 4, the second protrusion 52 protrudes from each of the inner surface 32a and 34a so as to be interposed between the battery cells 12 adjacent to each other (the gap g1). In other words, the second protrusion 52 overlaps the battery cell 12 in the width direction D2 of the battery cell 12.

The second protrusion 52 is formed to extend along the height D3 of the cell 12. More specifically, in the embodiment of the upper case 22, the second protrusion 52 extends along the height D3 so as to extend over the entire inner surface 32a and the entire 34a. Alternatively, the second protrusion 52 may be provided only on a part of each of the inner surface 32a and 34a in the height-direction D3.

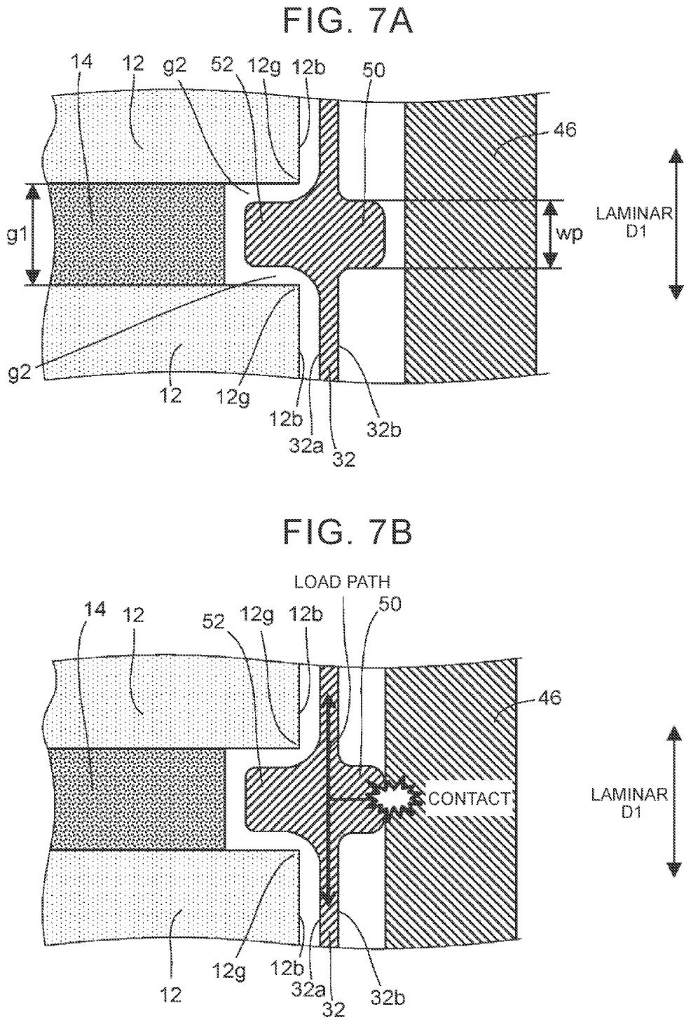

In addition, as shown in FIG. 7A below, a gap g2 (play) is provided between the second protrusion 52 and the battery cell 12 in the stacking-direction D1. Therefore, the battery cell 12 is positioned by the second protrusion 52 while being allowed to move within the gap g2. Further, for example, an angle R is formed at a root part of the second protrusion 52 with respect to each of the inner surface 32a and 34a.

The first protrusion 50 is formed so as to protrude from the outer surface of the upper case 22 to the outer side of the upper case 22 at a position in the gap g1 between the adjacent battery cells 12 in the stacking-direction D1. In the upper case 22, the first protrusions 50 are formed on the outer surfaces 32b and 34b of the pair of side walls 32 and 34, respectively. As shown in FIG. 4, the first protrusion 50 protrudes outward from each of the outer surface 32b and 34b. More specifically, as illustrated in FIG. 7A, the first protrusion 50 in the stacking-direction D1 has a width wp of, for example, the gap g1 or less.

The first protrusion 50 is also formed to extend along the height D3 of the cell 12. More specifically, in the embodiment of the upper case 22, as shown in FIG. 6, the first protrusion 50 extends in the height-direction D3 so as to cover all or substantially all of each of the outer surface 32b and 34b. Alternatively, the first protrusion 50 may be provided only on a part of each of the outer surface 32b and 34b in the height-direction D3.

In the upper case 22, basically, the first protrusion 50 and the second protrusion 52 are provided in pairs with respect to the same gap g1 of the adjacent battery cells 12. That is, the second protrusion 52 is formed on each of the side wall 32 and the side wall 34 inside the first protrusion 50. However, like the second protrusions 521 (see FIG. 4) provided at the ends of the lamination-direction D1, the “first and second protrusions” according to the present disclosure may not necessarily be combined. In addition, instead of the example shown in FIG. 4, the first protrusion 50 may be formed on only one of the pair of side walls 32 and 34. Note that, as in the case of the convex portion 56 (see FIG. 4) provided at the end of the stacking-direction D1, a convex portion for positioning the battery cell 12 may be provided between the battery cell 12 and the case end wall (for example, each of the end walls 36 and 38).

### Effects

FIG. 4 is an enlarged view of a portion D of 7A and 7B. FIG. 7A corresponds to a condition in which no impact is applied to the side wall 32 of the upper case 22 from the peripheral member of the upper case 22. In contrast, FIG. 7B corresponds to an example in which an impact is applied to the side wall 32 from the cross member 46, which is an example of a member around the upper case 22. The load caused by the impact from the cross member 46 is transmitted to the battery cell 12 via the side wall 32.

If the first protrusion 50 is not provided on the outer surface 32b of the side wall 32, the load due to the impact from the cross member 46 is inputted to the side surface 12b (planar part) of the respective battery cells 12 via the side wall 32.

On the other hand, according to the upper case 22 of the present embodiment, the first protrusion 50 is provided on the outer surface 32b of the side wall 32. As a result, the cross member 46 first contacts the first protrusion 50 as shown in FIG. 7B. Consequently, the side wall 32 is deflected, and the corner portion 12g of the battery cell 12 contacts the side wall 32 before the side surface 12b. The corner portion 12g is a portion that is more rigid in shape than the side surface 12b. That is, by providing the first protrusion 50, the load caused by the impact from the cross member 46 can be caused to act on the corner portion 12g which is relatively stiff without directly hitting the side surface 12b of the battery cell 12. Further, as indicated by an arrow with a “load path” in FIG. 7B, the load inputted to the first protrusion 50 from the cross member 46, it is possible to receive and flow to the side wall 32 which is deflected by the impact. That is, the load can be absorbed by the side wall 32 provided with the first protrusion 50. This leads to a reduction in the load input to the battery cell 12.

As described above, by providing the first protrusion 50, the impact load applied to the battery cell 12 from the surrounding member such as the cross member 46 via the side wall 32 can be reduced. As a result, the battery cell 12 can be protected from the impact. More specifically, damage to battery components (e.g., electrode bodies) inside the battery cells 12 can be reduced. The same applies to the first protrusion 50 provided on the other side wall 34.

Further, according to the present embodiment, the second protrusion 52 is provided on the inner surface 32a of the side wall 32. As a result, the battery cells 12 constituting the cell stack 10 can be positioned. As a result, the insulation distance between the adjacent battery cells 12 can be ensured. In addition, a plurality of bus bars for electrically connecting a plurality of battery cells 12 constituting the cell stack 10 are arranged on the upper wall 30 of the upper case 22. Each of the plurality of bus bars is connected to an electrode terminal of the battery cell 12 by welding or the like. Since the positioning of each battery cell 12 with respect to the upper case 22 is appropriately performed by using the second protrusion 52, the position of the bus bar with respect to each battery cell 12 is also easily determined. As a result, the weldability of the bus bar is improved. Further, when the upper case 22 is made of resin, the following effects can be obtained. That is, by providing the second protrusion 52, when the upper case 22 is manufactured by an injection molding machine, the fluidity of the resin can be improved as compared with an example in which the second protrusion 52 is not provided. As a result, it is possible to suppress the occurrence of short shots while suppressing an increase in the tonnage of the injection molding machine. The same applies to the second protrusion 52 provided on the other side wall 34.

In addition, according to the upper case 22 of the present embodiment, the first protrusion 50 and the second protrusion 52 are basically provided in pairs with respect to the same gap g1. Accordingly, when the upper case 22 is made of resin, the above-described effects (i.e., reduction of the impact load on the battery cell 12 and positioning of the battery cell 12) can be obtained while effectively increasing the fluidity of the resin.

As illustrated in FIG. 7A, the first protrusion 50 in the stacking-direction D1 may have a width wp equal to or smaller than a gap g1 between adjacent cells 12. As a result, compared with the case where the width wp is larger than the gap g1, the load caused by the impact received by the first protrusion 50 from the cross member 46 can be less likely to be transmitted to the side surface 12b or 12c of the battery cell 12 (in other words, it can be easily transmitted to the corner portion 12g in a concentrated manner).

### First Rib

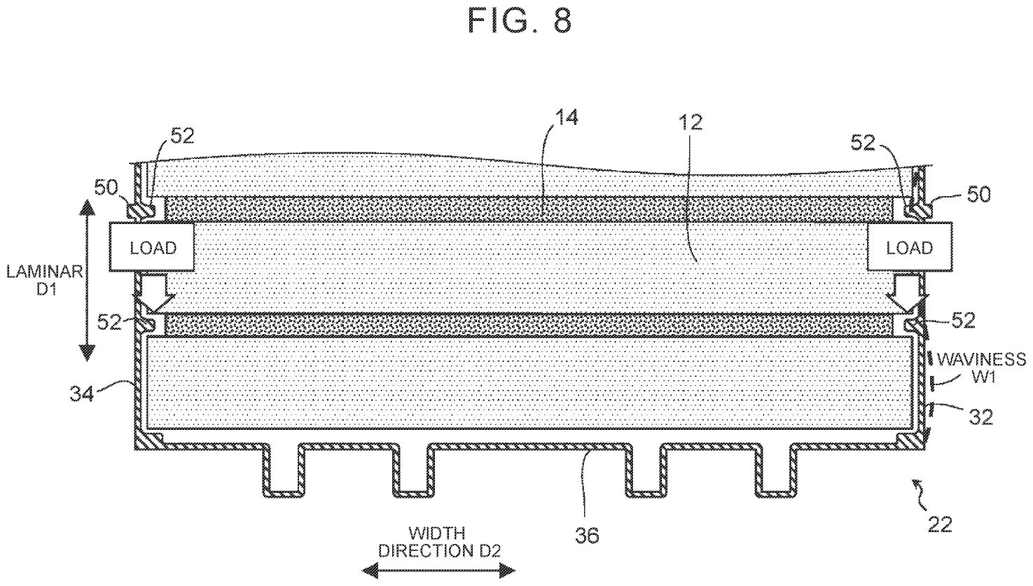

FIG. 8 is a diagram for explaining an additional problem I1 according to the embodiment. FIG. 8 is a cross-sectional view in the same position as FIG. 4. Here, an additional problem I1 will be described by exemplifying the side wall 32.

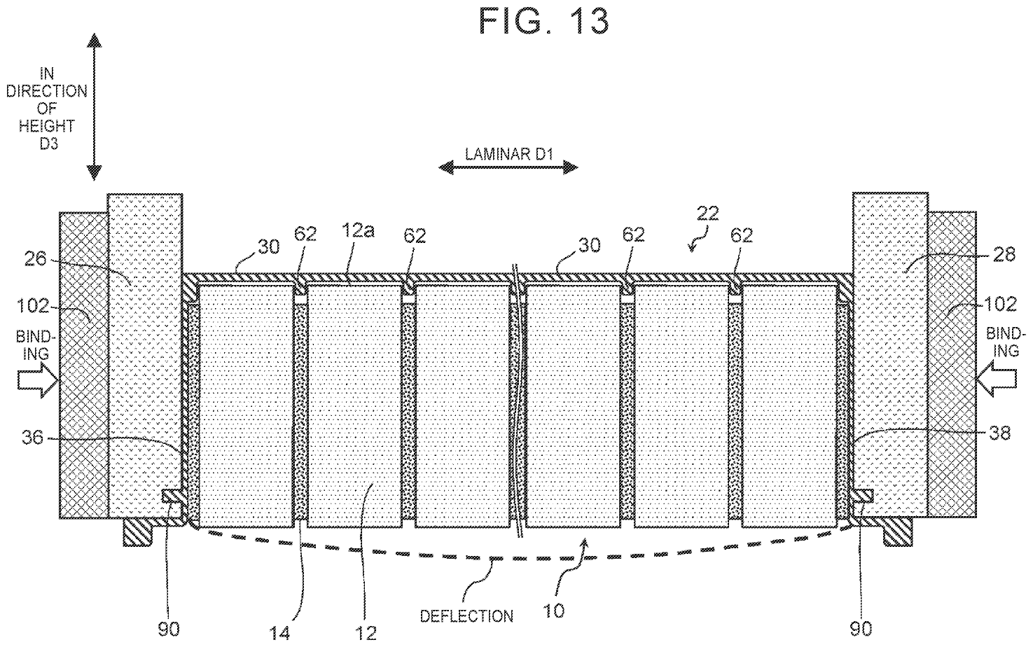

If the second protrusion 52 is provided on the side wall 32, a “waviness W1” may occur on the side wall 32 as shown in FIG. 8. Specifically, as will be described later with reference to FIG. 13, mounting of the upper case 22 on the lower case 24 is performed while a restraining load along the stacking-direction D1 is applied by the pair of jigs 102 to the upper case 22 accommodating the cell stack 10. When such a restraining load is applied, each of the second protrusions 52 receives a load in the stacking-direction D1 from the surrounding battery cells 12 as shown in FIG. 8. Consequently, a waviness W1 may occur. Then, the waviness W1 is generated along the stacking-direction D1 as shown in FIG. 8. When the upper case 22 is made of plastic, the waviness W1 may be caused not only by the above-described factors but also by the warpage of the side wall 32 that may occur when the upper case 22 is molded.

When the above-described waviness W1 occurs, the mountability of the upper case 22 with respect to the lower case 24 decreases. In view of such additional problem I1, in the present embodiment, the upper case 22 includes the first rib 60. The first rib 60 is integrally formed with the upper case 22. As shown in FIG. 6, the first rib 60 is formed on the outer surface 32b of the side wall 32 on which the first protrusion 50 and the second protrusion 52 are formed. For example, a plurality of first ribs 60 is provided.

Specifically, as shown in FIG. 6, each of the first ribs 60 is formed so as to extend parallel to the stacking-direction D1. Alternatively, each of the first ribs 60 may be formed to extend obliquely with respect to the stacking direction D1. That is, each of the first ribs 60 is not necessarily limited to a direction parallel to the stacking direction D1, and may extend in a direction inclined with respect to the direction.

More specifically, the first protrusion 50 is provided for each gap g1 of the adjacent battery cells 12 in the cell stack 10, and is formed so as to extend along the gap g1 of the adjacent battery cells 12 (that is, along the height-direction D3). FIG. 6 illustrates three first protrusions 50 formed in this manner. Moreover, each of the first ribs 60 is formed so as to bridge between adjacent first protrusions 50.

The first rib 60 described above may be similarly formed with respect to the other side wall 34.

### Effects

According to the present embodiment, by providing the first ribs 60, it is possible to increase the stiffness of the side wall 32 (and the side wall 34) with respect to the waviness W1. As a result, waviness W1 caused in the side wall 32 (and the side wall 34) due to the presence of the second protrusion 52 described above can be effectively suppressed.

### Third Protrusion and Second Rib

The upper case 22 further includes a third protrusion 62. The third protrusion 62 is integrally formed with the upper case 22. As shown in FIG. 1, the third protrusions 62 are basically provided between the respective battery cells 12 in the plurality of battery cells 12 constituting the cell stack 10.

Similar to the second protrusions 52, the third protrusions 62 are provided for positioning the cells 12 in the stacking-direction D1. Specifically, the third protrusion 62 is formed on the inner surface of the upper case 22. In the upper case 22, the third protrusion 62 is formed on the inner surface 30a of the upper wall 30 of the upper case 22. As shown in FIG. 1, the third protrusion 62 protrudes from the inner surface 30a so as to be interposed between the adjacent battery cells 12 (the gap g1). In other words, the third protrusion 62 overlaps the battery cell 12 in the height-direction D3 of the battery cell 12.

The third protrusion 62 is formed to extend along the width direction D2 of the cell 12. More specifically, in the case of the upper case 22, the third protrusion 62 extends along the width direction D2 so as to cover the entire inner surface 30a. As can be seen from FIG. 5, the third protrusion 62 is continuous with the second protrusion 52 formed on the inner surface 32a and 34a of the pair of side walls 32 and 34, respectively. Alternatively, the third protrusion 62 may be provided only on a part of the inner surface 30a in the width direction D2.

In addition, similarly to the second protrusion 52, a gap g2 (play) is provided between the third protrusion 62 and the battery cell 12 in the stacking-direction D1. Therefore, the battery cells 12 are positioned by the third protrusions 62 while being allowed to move within the gap g2. Note that, like the protrusions 64 (see FIG. 1) provided at the ends of the stacking-direction D1, the protrusions for positioning the battery cells 12 may be provided between the battery cells 12 and the case end walls (for example, the end walls 36 and 38, respectively).

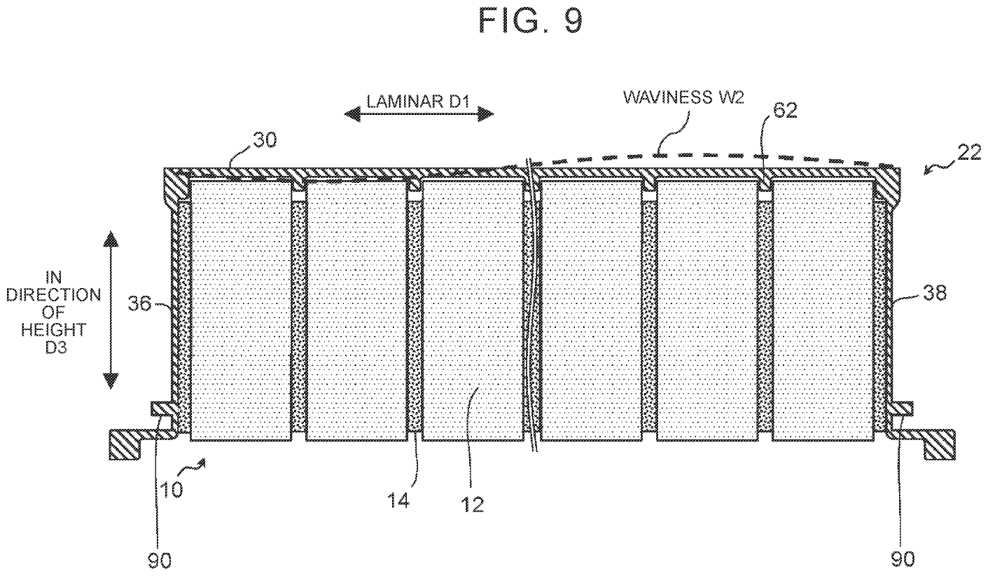

FIG. 9 is a diagram for explaining an additional problem I2 according to the embodiment. FIG. 9 is a cross-sectional view in the same position as FIG. 1. When the third protrusion 62 is provided on the upper wall 30, a “waviness W2” may occur on the upper wall 30 as shown in FIG. 9. Specifically, similar to the above-described waviness W1 that may occur in the side walls 32 (and 34), the waviness W2 may be caused by the third protrusion 62 receiving a load from the surrounding battery cells 12 when a restraint load along the stacking-direction D1 is applied to the upper case 22. The waviness W2 is generated along the stacking-direction D1 as shown in FIG. 9. When the upper case 22 is made of plastic, the waviness W2 may be caused not only by the above-described factors but also by the warpage of the upper wall 30 that may occur when the upper case 22 is molded.

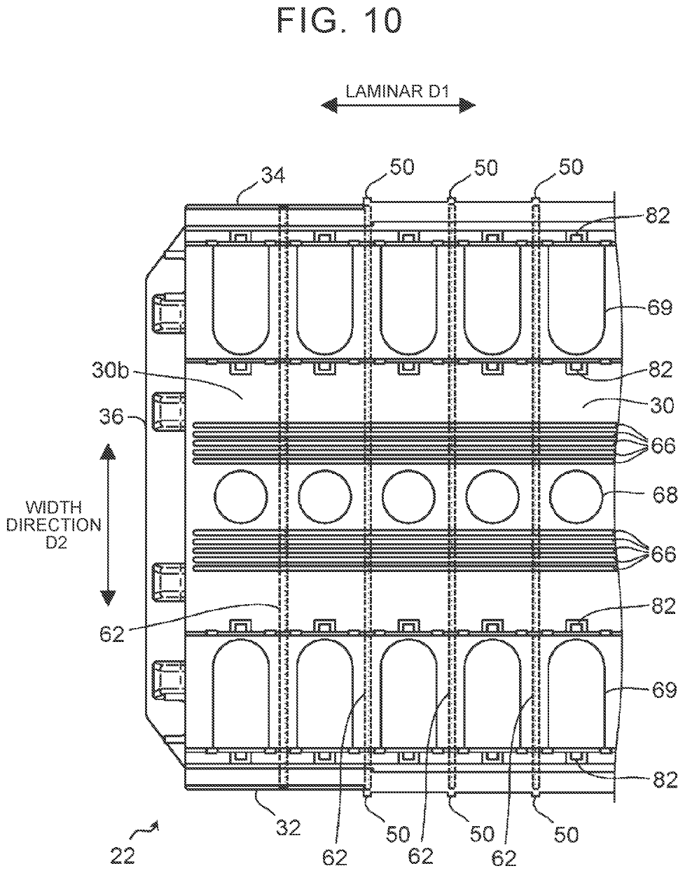

FIG. 10 is an upper surface portion of the upper case 22 shown in FIG. 1 viewed from the side of the upper wall 30. When the above-described waviness W2 occurs, the mountability of the upper case 22 with respect to the lower case 24 decreases. In view of such additional problem I2, in the present embodiment, the upper case 22 includes the second rib 66. The second rib 66 is integrally formed with the upper case 22. As shown in FIG. 10, the second ribs 66 are formed on the outer surface 30b of the upper wall 30. For example, a plurality of second ribs 66 is provided.

Each of the second ribs 66 is formed so as to extend parallel to the stacking-direction D1. Alternatively, each of the second ribs 66 may be formed to extend obliquely with respect to the stacking-direction D1. That is, each of the second ribs 66 is not necessarily limited to a direction parallel to the stacking direction D1, and may extend in a direction inclined with respect to the direction.

In addition, since each of the second ribs 66 is formed so as to extend parallel or obliquely to the stacking direction D1 as described above, when the upper wall 30 is viewed from a direction perpendicular to the upper wall 30 (that is, in FIG. 10), each of the second ribs 66 extends so as to intersect with the third protrusion 62.

As shown in FIG. 10, a plurality of through holes 68 are formed in the upper wall 30 in the center of the cell 12 in the width direction D2 along the stacking direction D1. The plurality of through holes 68 are formed at positions corresponding to the safety valves provided on the upper surface 12a of the respective battery cells 12. The second ribs 66 are formed on both sides of the plurality of through holes 68 in the width direction D2. In addition, a plurality of through holes 69 is formed in the upper wall 30 to expose the electrode terminals of the battery cells 12 to the outside of the upper case 22.

### Effects

According to the present embodiment, by providing the second ribs 66, it is possible to increase the stiffness of the upper wall 30 with respect to the waviness W2. As a result, it is possible to effectively suppress the waviness W2 caused in the upper wall 30 due to the presence of the above-described third protrusion 62.

### Modification

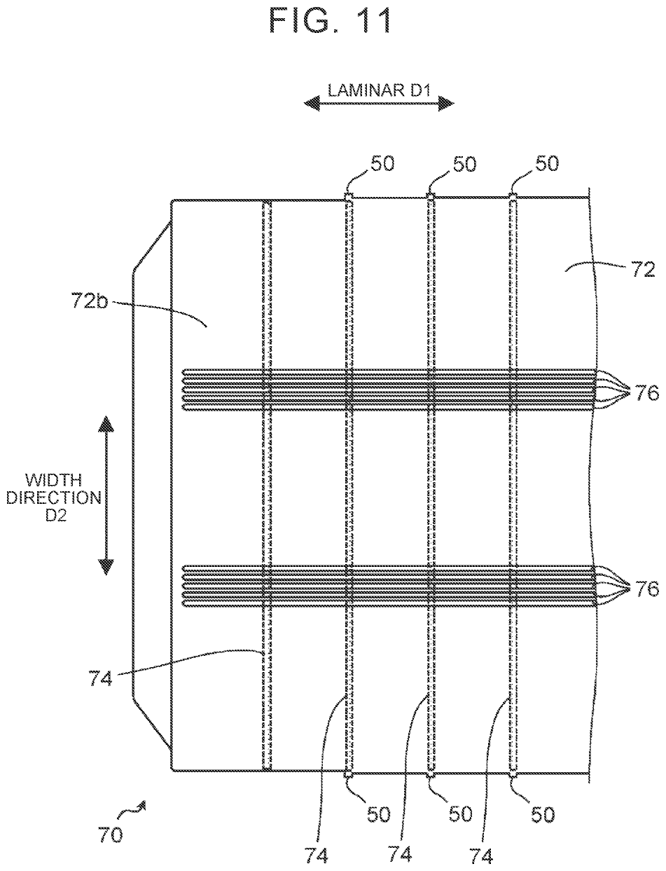

FIG. 11 is a bottom view of the lower case 70 according to the modification of the embodiment as viewed from the side of the bottom wall 72. The battery pack according to this modification includes the cell stack 10 and a battery case. The battery case is formed in a substantially rectangular parallelepiped shape and houses the cell stack 10. The battery case includes a lower case 70 and an upper case (or an upper cover) (not shown).

The lower case 70 includes a bottom wall 72 and four side walls. The bottom wall 72 faces the bottom surface 12f of the cells 12 constituting the cell stack 10. Although not shown here, the four side walls are configured similarly to the four side walls 32-38 described above. The bottom wall 72 and the four side walls are integrally formed. The upper case includes an upper wall facing the upper surface 12a of the respective battery cells 12 constituting the cell stack 10.

In the example illustrated in FIG. 10 described above, the third protrusion 62 and the second rib 66 are integrally formed on the upper wall 30. In contrast, in the modification illustrated in FIG. 11, the third protrusion 74 and the second rib 76 are integrally formed with the bottom wall 72. Specifically, the third protrusion 74 protrudes from the inner surface of the bottom wall 72 so as to be interposed between the adjacent battery cells 12. The third protrusions 74 are basically provided between the respective battery cells 12 in the plurality of battery cells 12 constituting the cell stack 10. The second ribs 76 are formed on the outer surface 72b of the bottom wall 72. For example, a plurality of second ribs 76 is provided.

Each of the second ribs 76 is formed so as to extend parallel to the stacking-direction D1. Alternatively, each of the second ribs 76 may be formed to extend obliquely with respect to the stacking-direction D1. That is, each of the second ribs 76 is not necessarily limited to a direction parallel to the stacking direction D1, and may extend in a direction inclined with respect to the direction. Since each of the second ribs 76 is formed so as to extend parallel or obliquely with respect to the stacking direction D1 in this manner, when the bottom wall 72 is viewed from a direction perpendicular to the bottom wall 72 (that is, in FIG. 11), each of the second ribs 76 extends so as to intersect the third protrusion 74.

According to the above-described modification, by providing the second rib 76, it is possible to increase the stiffness of the bottom wall 72 with respect to the waviness that may be generated in the bottom wall 72 in the same manner as the above-described waviness W2. As a result, it is possible to effectively suppress the waviness caused in the bottom wall 72 due to the presence of the above-described third protrusion 74.

### Other Configurations and Effects of the Battery Case

### Bus Bar Module Mounting Claws

A bus bar module 80 is mounted on the upper wall 30 of the upper case 22. More specifically, two bus bar modules 80 are mounted. Each bus bar module 80 includes a plurality of bus bars connected to electrode terminals of a plurality of battery cells 12 constituting the cell stack 10 by welding or the like, and a resin bus bar case that supports the plurality of bus bars.

The upper wall 30 includes a plurality of claws 82 for attaching each bus bar module 80 to the upper wall 30. The plurality of claws 82 are integrally formed with the upper wall 30. Each battery cell 12 is positioned with respect to the upper case 22 by the second protrusion 52 and the third protrusion 62 described above. Therefore, by attaching the bus bar module 80 to the upper wall 30 of the upper case 22 using the plurality of claws 82, the plurality of bus bars in the bus bar module 80 are installed at a place (for example, a place where welding is possible) where the bus bars can be attached to the electrode terminals of the corresponding battery cells 12.

As described above, the upper case 22 of the present embodiment has a function of protecting the battery cell 12 by the first protrusion 50, a function of positioning the battery cell 12 by the second protrusion 52 and the third protrusion 62, and also a function of assisting the attachment of the bus bar.

### Protection of Battery Cells Using Restraining Members

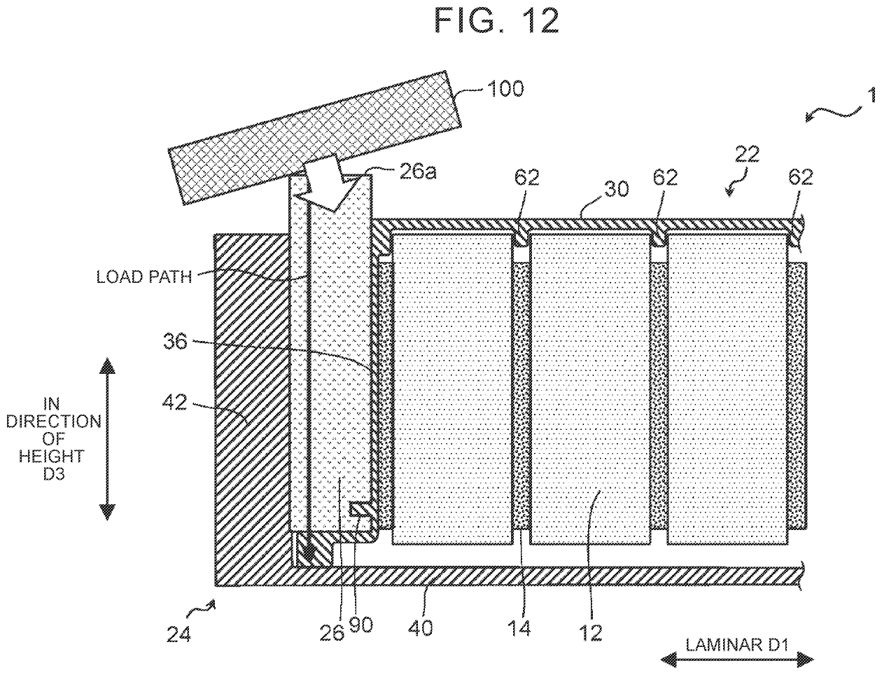

FIG. 12 is a diagram for explaining the structure of the restraining members 26 and 28 shown in FIG. 1. Here, the restraining member 26 will be described as an example, but the other restraining member 28 is configured in the same manner.

FIG. 12 shows an intruder 100 into the battery pack 1 from above. The intruder 100 is, for example, a structural member (for example, a floor panel) of an electrified vehicle on which the battery pack 1 is mounted. When the impact load is inputted to electrified vehicle, the intruder 100 may come from above toward the battery pack 1 as shown in FIG. 12.

In order to protect the battery cell 12 against the above-described intruder 100, the restraining member 26 is formed and arranged such that its upper surface 26a is at least higher than that of the battery cell 12. More specifically, in the embodiment illustrated in FIG. 12, the upper surface 26a of the restraining member 26 is formed and arranged to be higher than the upper wall 30 of the upper case 22. In addition, the upper surface 26a may be formed and arranged to be higher than the mounting components of the upper case 22, such as the bus bar module 80 (see FIG. 3) mounted on the upper wall 30.

According to the restraining member 26 formed and arranged as described above, when the intruder 100 approaches the battery pack 1, the restraining member 26 comes into contact with the intruder 100 first. The load input from the intruder 100 to the restraining member 26 is received by the lower case 24 instead of the battery cell 12 as shown in FIG. 12. That is, it is possible to prevent the load from the intruder 100 from being directly input to the battery cell 12. Therefore, the battery cell 12 can be protected from the intruder 100.

### Case Lifting Claws

FIG. 13 is a diagram for explaining an additional problem I3 according to the embodiment. FIG. 13 is a cross-sectional view in the same position as FIG. 1. Mounting of the upper case 22 on the lower case 24 is performed while a restraining load along the stacking-direction D1 is applied to the upper case 22 accommodating the cell stack 10 by the pair of jigs 102. The pair of jigs 102 and the restraining members 26 and 28 are formed so as to be capable of being caught by each other.

When the upper case 22 is lifted by applying a restraining load using the pair of jigs 102, the upper case 22 is deformed by the weight of the cell stack 10. As a result, as represented by a broken line in FIG. 13, “deflection” occurs in the cell stack 10. This leads to a decrease in workability during the production of the battery pack 1 (an additional problem I3).

In view of the above-described additional problem I3, the upper wall 30 of the upper case 22 includes a pair of claws (claws for lifting the case) 84 for lifting the upper case 22. The pair of claws 84 are integrally formed with the upper wall 30 to hook a pair of auxiliary jigs 104 (see FIG. 3) for preventing the aforementioned “deflection”. More specifically, with respect to the width direction D2 of the battery cells 12, as shown in FIG. 3, the pair of claws 84 are provided at respective end portions of the upper wall 30 in the width direction D2. Further, although not shown, with respect to the stacking direction D1, the pair of claws 84 is provided in the central portion (in other words, the central portion of the cell stack 10) of the upper wall 30 in the stacking direction D1.

By integrally providing the pair of claws 84 with the upper case 22 described above, deformation of the upper case 22 and “deflection” of the cell stack 10 associated therewith when the upper case 22 is lifted can be suppressed without increasing the number of parts.

### Positioning of the Restraining Member

As shown in FIGS. 1 and 3, the end wall 36 of the upper case 22 includes a pin 90 for positioning the restraining member 26. The pin 90 is provided at two places as an example. Similarly, the other end wall 38 also includes a pin 90 for positioning the restraining member 28. The pins 90 are integrally formed with the upper case 22. In addition, the restraining members 26 and 28 are formed with recesses 26b and 28b that engage with the pins 90, respectively.

Before lifting the upper case 22 using the pair of jigs 102 described above, the upper case 22 and the restraining members 26 and 28 are laminated as shown in FIG. 1. By providing the positioning pin 90, the restraining members 26 and 28 can be positioned with respect to the upper case 22 during the lamination without increasing the number of components. In order to position the restraining members 26 and 28, in contrast to the above configuration example, a pin may be provided on the side of the restraining members 26 and 28, and a recess may be provided on the side of the end walls 36 and 38 to engage with the pin.

### Another Configuration Example of the Battery Case

In the above-described example of the battery case 20, the first protrusion 50 is formed on the pair of side walls 32 and 34 of the upper case 22. Alternatively, the “first protrusion” may be formed on at least one of the top wall and the bottom wall of the battery case.

In the example of the battery case 20, the second protrusions 52 are formed on the pair of side walls 32 and 34, and the third protrusions 62 are formed on the upper wall 30. Instead of such an example, the battery case may include only one of the “second convex portion” and the “third convex portion”.

In the example of the battery case 20, the first protrusion 50 and the second protrusion 52 are provided in pairs. Instead of such an example, the “first protrusion” may be provided alone.

What is claimed is:

1. A battery pack comprising:
a cell stack configured by stacking a plurality of battery cells with a substantially rectangular parallelepiped shape; and
a battery case provided in a substantially rectangular parallelepiped shape and accommodating the cell stack, wherein the battery case includes a first protrusion protruding from an outer surface of the battery case to an outside of the battery case at a position of a gap between adjacent battery cells in a stacking direction of the cell stack.

2. The battery pack according to claim 1, wherein:
the battery case includes a pair of side walls, the pair of side walls extending along the stacking direction and facing a side surface of the cell stack; and
the first protrusion is provided on at least one of the pair of side walls.

3. The battery pack according to claim 1, wherein the battery case includes a second protrusion that protrudes from an inner surface of the battery case to be interposed between the adjacent battery cells on an inner side of the first protrusion.

4. The battery pack according to claim 3, wherein:
the battery case includes a pair of side walls, the pair of side walls extending along the stacking direction and facing a side surface of the cell stack;
the first protrusion and the second protrusion are provided on at least one of the pair of side walls;
the battery case includes a first rib provided on an outer surface of at least one of the pair of side walls on which the first protrusion and the second protrusion are provided; and
the first rib is provided to extend parallel or obliquely to the stacking direction.

5. The battery pack according to claim 4, wherein:
the first protrusion provided on at least one of the pair of side walls is provided for each gap of the adjacent battery cells in the cell stack, and the first protrusion provided on at least one of the pair of side walls is provided so as to extend along a gap of the adjacent battery cells; and
the first rib is provided so as to bridge between the first protrusions adjacent to each other.

6. The battery pack according to claim 1, wherein:
the battery case includes an upper wall extending along the stacking direction and facing an upper surface of the cell stack;
the battery case includes a third protrusion protruding from an inner surface of the upper wall so as to be interposed between the adjacent battery cells; and
the battery case includes a second rib provided on an outer surface of the upper wall, wherein the second rib is provided so as to extend parallel or obliquely to the stacking direction.

7. The battery pack according to claim 1, wherein:
the battery case includes a bottom wall extending along the stacking direction and facing a bottom surface of the cell stack;
the battery case includes a third protrusion protruding from an inner surface of the bottom wall so as to be interposed between the adjacent battery cells; and
the battery case includes a second rib provided on an outer surface of the bottom wall, wherein the second rib is provided to extend parallel or obliquely to the stacking direction.
